(19) United States
(12) Patent Application Publication
(10) Pub. No.: US 2007/0212465 A1
(43) Pub. Date: Sep. 13, 2007

(54) Methods and apparatus for processing food

(76) Inventors: Shahzar Amirali Visram, Brooklyn, NY (US); Jessica Thatcher Crolick Rolph, Edina, MN (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/374,459

(22) Filed: Mar. 13, 2006

(51) Int. Cl. A23L 3/36

(52) U.S. Cl. 426/524

(57) ABSTRACT

A method for processing food using a tray having a plurality of substantially similarly-sized compartments. The method includes at least partially filling at least two of the plurality of substantially similarly-sized tray compartments with an organic food, and flash-freezing the organic food within the plurality of substantially similarly-sized tray compartments.

### BACKGROUND OF THE INVENTION

This invention relates generally to food products, and more specifically to methods and apparatus for processing food products.

Food produced without the use of genetically modified organisms (GMOs) or synthetic chemicals, such as, but not limited to synthetic pesticides, preservatives, herbicides, fertilizers, antibiotics, and/or hormones, is sometimes referred to as organic food. At least some organic food is considered to have higher nutritional value, a better taste, and a positive impact on the environment as such food contains no toxic residue from synthetic chemicals. As such, many parents choose organic food as the healthiest option to feed their babies. However, to facilitate extending a shelf-life of such food products, at least some known commercially available baby foods are limited to canned or jarred foods that are cooked at temperatures exceeding 250° F. As a result of such cooking, much of the nutrients, taste, and natural color are “cooked out” of the foods.

### BRIEF DESCRIPTION OF THE INVENTION

In one aspect, a method is provided for processing food using a tray having a plurality of substantially similarly-sized compartments. The method includes at least partially filling at least two of the plurality of substantially similarly-sized tray compartments with an organic food, and flash-freezing the organic food within the plurality of substantially similarly-sized tray compartments.

In another aspect, a method is provided for processing food using a tray having a plurality of compartments. The method includes cooking food to a temperature no greater than about 212° F. for a duration of between about two minutes and about thirty minutes, at least partially filling at least one of the plurality of tray compartments with the food, and freezing the food within the plurality of tray compartments.

In another aspect, a method is provided for processing baby food using a tray having a plurality of compartments. The method includes cooking food, pureeing the cooked food to a consistency suitable for consumption by a human baby between the ages of about six months and about eighteen months, chilling the pureed food, at least partially filling each of the plurality of tray compartments with the chilled food, and freezing the chilled food within the plurality of tray compartments.

### BRIEF DESCRIPTION OF THE DRAWINGS

FIG. 1 is a perspective view of an exemplary embodiment of a tray that may be used to contain food.

FIG. 2 is a plan view of the tray shown in FIG. 1.

FIG. 3 is a side view of the tray shown in FIG. 1.

FIG. 4 is a flowchart illustrating an exemplary method for processing food using the tray shown in FIGS. 1-3.

### DETAILED DESCRIPTION OF THE INVENTION

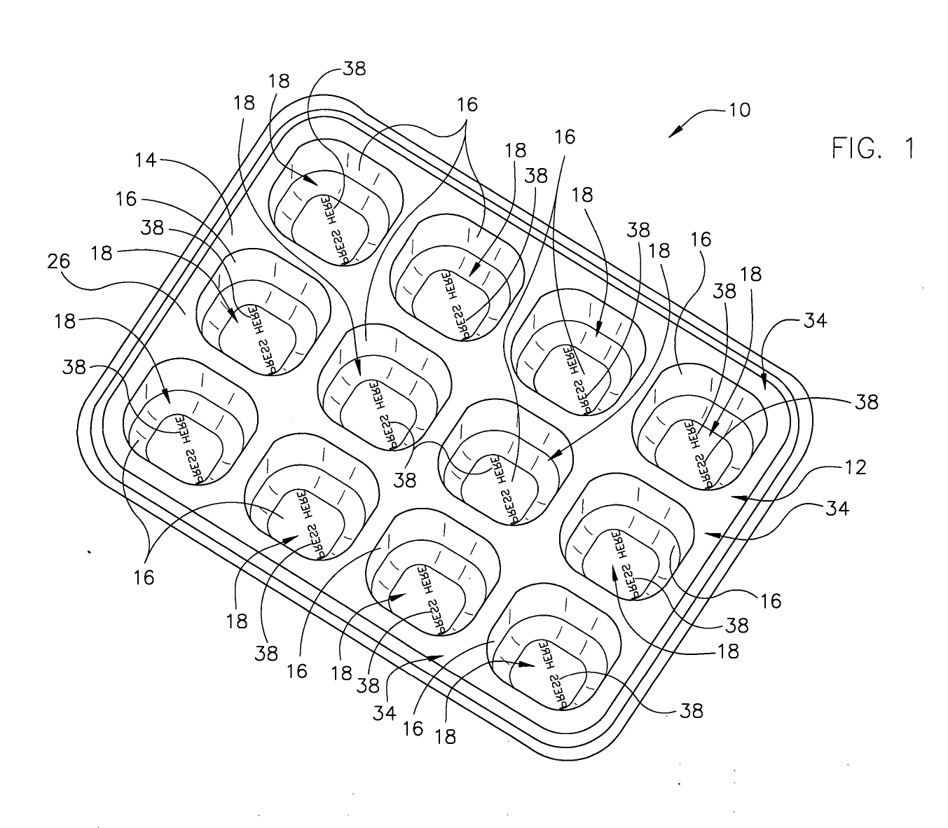

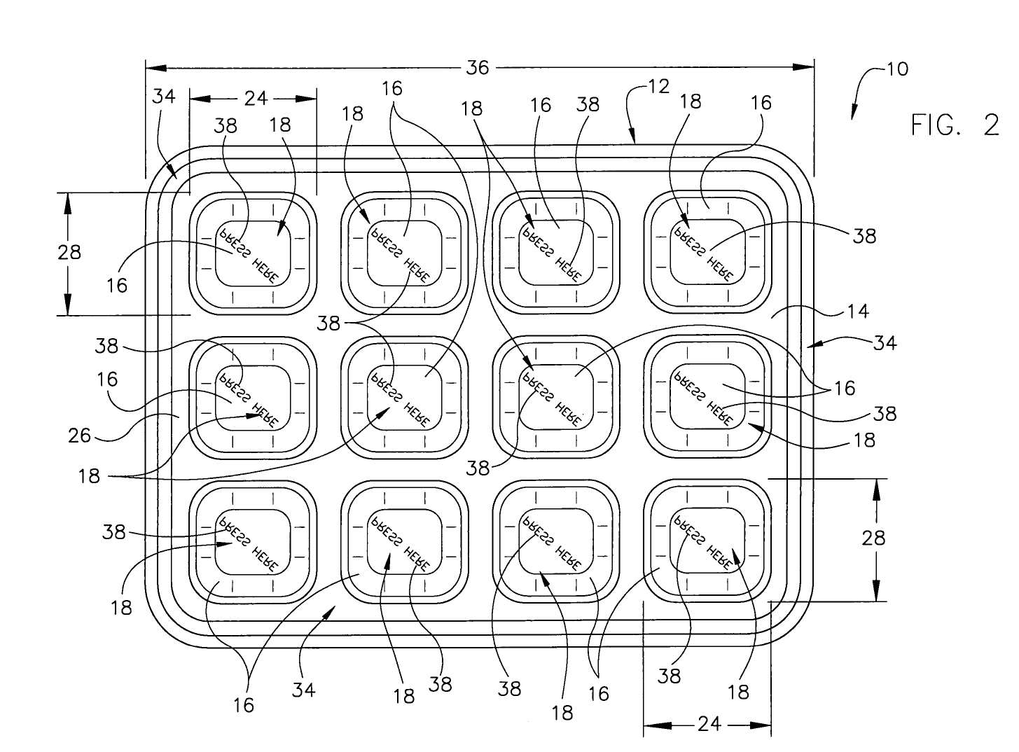

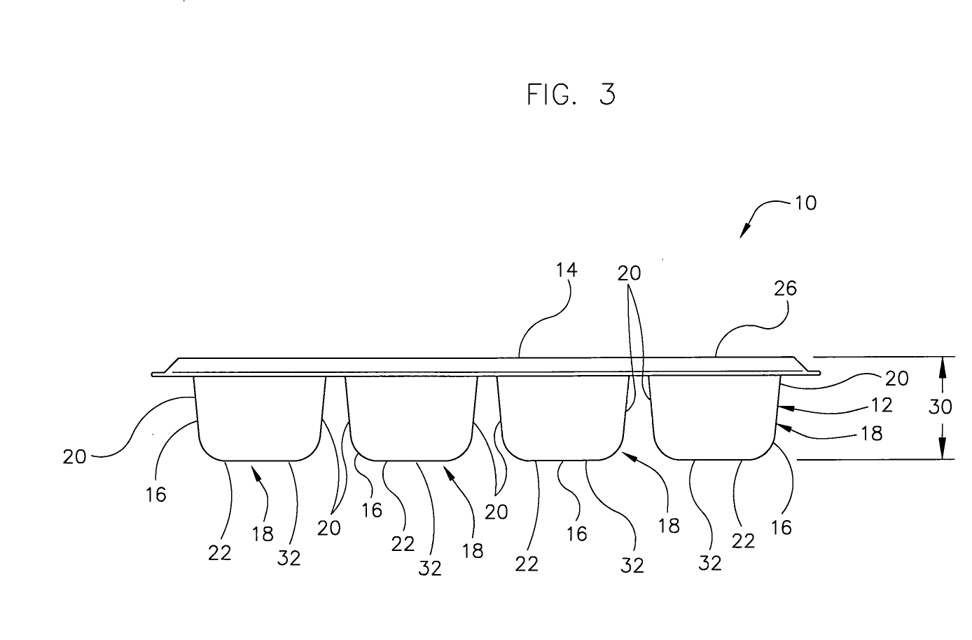

FIG. 1 is a perspective view of an exemplary embodiment of a tray 10 that may be used to contain food (not shown in FIG. 1). FIG. 2 is a plan view of tray 10. FIG. 3 is a side view of tray 10. As used herein, “food” is define as any substance that can be metabolized by an organism to give energy and build tissue. In the exemplary embodiment, tray 10 includes a body 12 having a top portion 14, an upper surface 26 of which is generally planar, and a plurality of recessed portions 16 that each extend outwardly from top portion 14. Each recessed portion 16 defines a separate compartment 18 for containing food, such as, but not limited to, frozen food. Each recessed portion 16 includes, and thus each compartment 18 is defined by, a sidewall portion 20 that extends outwardly from top portion 14 to a bottom portion 22 of the compartment 18.

In the exemplary embodiment, each compartment 18 is substantially identical. Alternatively, each compartment 18 may have any suitable size(s) and/or shape(s), whether such size(s) and/or shape(s) is described and/or illustrated herein, and whether such size(s) and/or shape(s) is the same or different from one or more other compartments 18. For example, in the exemplary embodiment, each compartment 18 has a generally rectangular cross-sectional shape that tapers inwardly from top portion 14 towards bottom portion 22. In the exemplary embodiment, each compartment 18 has a length 24 and a width 28. Length 24 is measured between opposite sidewall portions 20 at the intersection between sidewall portions 20 and an upper surface 26 of top portion 14, and width 28 is measured between opposite sidewall portions 20 at the intersection between sidewall portions 20 and top portion upper surface 26. In the exemplary embodiment, length 24 is between about 1.0 and about 2.0 inches and width 28 is between about 1.0 inches and about 2.0 inches. Moreover, in the exemplary embodiment, each compartment 18 has a depth 30 measured between top portion upper surface 26 and a lower surface 32 of each compartment bottom portion 22. In the exemplary embodiment, each compartment depth 30 is between about 1.0 inches and about 2.0 inches.

Although only twelve compartments 18 are illustrated, tray 10 may include any number of compartments 18. Moreover, compartments 18 may have any suitable configuration and/or arrangement relative to other compartments 18 and/or other portions of tray 10. For example, in the exemplary embodiment, tray 10 includes three rows 34 of compartments 18 that each extend along a length 36 of tray 10. In the exemplary embodiment, each compartment row 34 includes four compartments 18 that are substantially evenly-spaced along tray length 36. Tray 10 may be fabricated from any suitable material(s) that enables tray 10 to function as described herein, such as, but not limited to polypropylene, plastic, corn starch, and/or sugar cane. In some embodiments, tray 10 includes indicia 38 that provides instructions indicating how to remove food, such as, but not limited to frozen food, from each compartment 18, as will be described in more detail below. Indicia 38 may be located anywhere on tray 10 and may be any word, symbol, or other text that facilitates providing instructions to a user. In the exemplary embodiment, indicia 38 includes the phrase “press here” located on a lower surface 32 of each compartment bottom portion 22. Moreover, in the exemplary embodiment, indicia 38 also includes a plurality of arrow symbols (not shown) that indicate where a user should apply on opposite sidewall portions of 20 of each compartment 18 to facilitate removing food from tray 10.

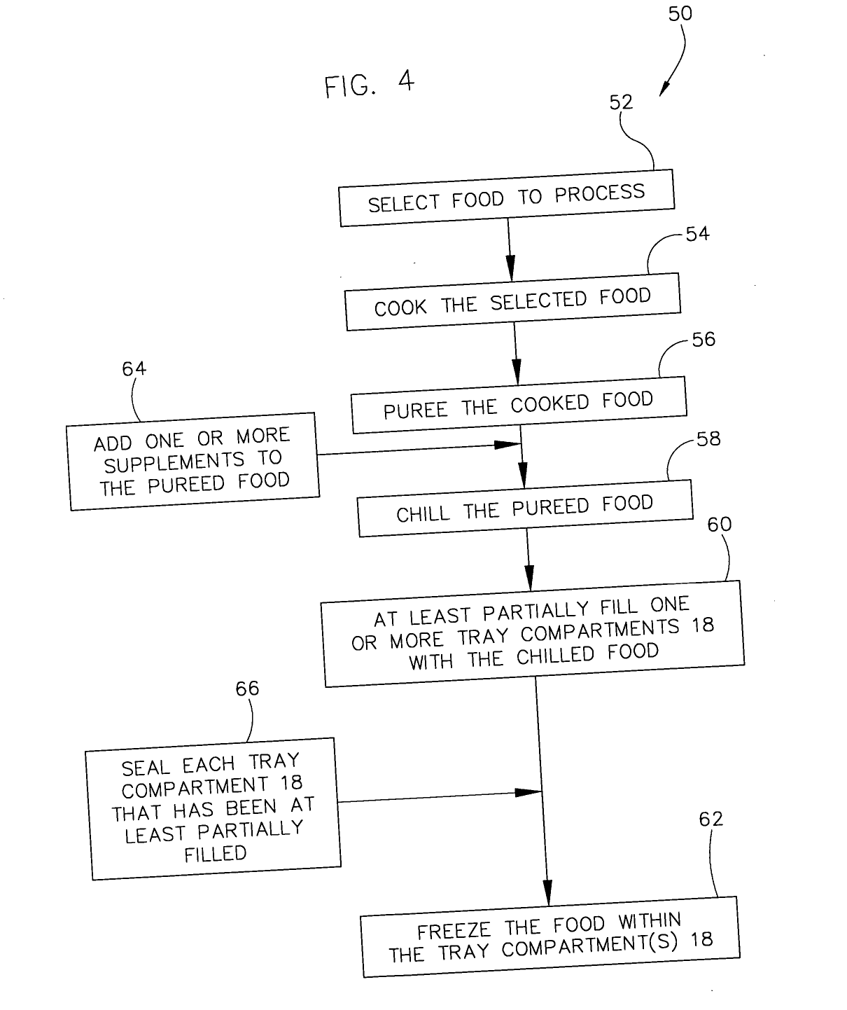

FIG. 4 is a flowchart illustrating an exemplary method 50 that may be used for processing food using tray 10. Although method 50 and tray 10 may be used to process any type of food for consumption, in the exemplary embodiment, method 50 and tray 10 will be described with respect to processing human baby food. More specifically, in the exemplary embodiment, method 50 and tray 10 will be described with respect to processing food suitable for consumption by human babies between the ages of about six months and about eighteen months. Method 50 generally includes selecting 52 food to process, cooking 54 the selected food, pureeing 56 the cooked food to a consistency suitable for consumption by a human baby between the ages of about six months and about eighteen months, and chilling 58 the pureed food. One or more of tray compartments 18 (shown in FIGS. 1-3) of tray 10 are then at least partially filled 60 with the chilled food, and the food is then frozen 62 within tray 10. Once frozen 62, tray 10 can be packaged for ultimate sale to a consumer. The frozen food can be removed from each filled compartment 18 by squeezing opposite sidewall portions 20 (shown in FIGS. 1-3) together to thereby push frozen food out of the compartment 18.

In some embodiments, method 50 includes adding 64 one or more supplements to the food, such as, but not limited to, vitamins, herbs, and/or fatty acids, to the food before freezing 62. Moreover, in some embodiments each tray compartment 18 that has been at least partially filled 60 is sealed 66 before freezing 62 to facilitate protecting the food from freezer bum.

The food selected 52 may include any type of food having any number of different ingredients, such as, but not limited to, raw food, generally fresh food, vegetables, fruits, meats, grains, grain products, and/or dairy products. In some embodiments, the food selected 52 does not include refined sugar. In some embodiments, the food selected 52 does not include any synthetic chemicals. In some embodiments, the food selected 52 is organic food. As used herein, “organic food” is defined as any food that is produced to include less than 10% by weight or volume of genetically modified organisms (GMOs) and synthetic chemicals, such as, but not limited to synthetic pesticides, preservatives, herbicides, fertilizers, antibiotics, and/or hormones. For example, in some embodiments the food selected 52 includes, but is not limited to including, organic vegetables, organic fruits, organic meats, organic grains, organic grain products, and/or organic dairy products. Moreover, in some embodiments the raw food selected is certified organic by the United States Department of Agriculture (USDA).

In some embodiments, a plurality of different types of food are selected 52 such that one or more tray compartments 18 may be filled with a different type of food than one or more other tray compartments 18. For example, in some embodiments, tray 10 includes at least two different types of frozen food. Each different type of food may include any number of different ingredients, some of which may be common to the other different type(s) of food.

The selected food may be cooked 54 using any suitable process, structure, and/or means. As used herein, “cook”, “cooking”, and “cooked” are defined as heating food to prepare the food for consumption. Moreover, the selected food may be cooked 54 at any temperature and for any duration of time. In the exemplary embodiment, the selected food is cooked 54 at a temperature of no greater than about 212° F. for a duration of between about two minutes and about thirty minutes. In some embodiments, and for example, the selected food is cooked for a duration of between about 2 minutes and about 15 minutes. Limiting the temperature at which the selected food(s) is cooked to no greater than about 212° F. and/or limiting a duration of cooking 54 to between about two minutes and about thirty minutes facilitates the food retaining more of its nutrients and flavor. In some embodiments, the selected food is cooked 54 in water. In alternative embodiments, method 50 does not include cooking 54 the selected food.

The selected food may be pureed 56 using any suitable process, structure, and/or means, such as, but not limited to, a grinding machine and/or a blending machine. The selected food may be pureed to any suitable consistency. In the exemplary embodiment, the selected food is pureed 56 to a consistency that is suitable for consumption by a human baby between the ages of about six months and about eighteen months. For example, in the exemplary embodiment the selected food is pureed 56 to consistency of: (1) between a thin liquid, such as, but not limited to, the consistency of water or juice, and a medium liquid, such as, but not limited to, the consistency of a nectar, which is suitable for consumption by a human baby between the ages of about six months and about nine months; (2) a thick liquid, such as, but not limited to, the consistency of a yogurt or a pudding, which is suitable for consumption by a human baby between the ages of about nine months and about twelve months; and/or (3) a thick liquid having chunks, such as, but not limited to, the consistency of a yogurt or a pudding with pearl-sized chunks, which is suitable for consumption by a human baby between the ages of about twelve months and about eighteen months. In alternative embodiments, method 50 does not include pureeing 56 the selected food.

The selected food may be chilled 58 using any suitable process, structure, and/or means. Moreover, the selected food may be chilled 58 to any temperature (i.e., chilled until it is at such temperature) and may be maintained at such temperature for any duration of time. Furthermore, the selected food may be chilled 58 for any duration of time to reach a desired temperature. In some embodiments, and for example, the selected food is chilled 58 to a temperature of between about 35° F. and about 65° F. Moreover, and for example, in some embodiments the selected food is chilled 58 to a temperature of between about 40° F. and about 60° F. Furthermore, and for example, in some embodiments the selected food is chilled 58 to a temperature of between about 45° F. and about 55° F. In alternative embodiments, method 50 does not include chilling 58 the selected food.

Each tray compartment 18 may be at least partially filled 60 with a selected food using any suitable process, structure, and/or means. For example, in some embodiments, tray compartments 18 are filled using an ALL-FILL Model 5125DB Twelve Piston Filling Liquid System, commercially available from All-Fill Inc. of Exton, Pa. Each tray compartment may be at least partially filled 60 with any amount of a selected food. For example, in some embodiments one or more tray compartments 18 are at least partially filled with between about 0.5 ounces and about 1.5 ounces of a selected food.

Each at least partially filled tray compartment 18 may be sealed 66 using any suitable process, structure, and/or means. For example, in some embodiments, one or more tray compartments 18 are sealed 66 by applying a film, such as, but not limited to a plastic film, to top portion upper surface 26 (shown in FIGS. 1-3) of tray 10. In alternative embodiments, method 50 does not include sealing 66 any at least partially filled tray compartments 18.

The selected food may be frozen 62 using any suitable process, structure, and/or means that does not include freeze-drying the food. Moreover, the selected food may be frozen 62 to any temperature (i.e., frozen until it is at such temperature) and may be maintained at such temperature for any duration of time. Furthermore, the selected food may be frozen 62 for any duration of time to reach a desired temperature. In some embodiments, and for example, the selected food is frozen to a temperature of between about −20° F. and about 32° F. Moreover, and for example, in some embodiments, the selected food is frozen to a temperature of between about −15° F. and about 20° F. Furthermore, and for example, in some embodiments, the selected food is frozen to a temperature of between about −10°F. and about 10° F. In some embodiments, freezing 62 the selected food includes flash-freezing the selected food, which is defined herein as exposing the selected food to a temperature that causes a temperature of the selected food to drop below 32° F. within less than ten seconds.

Supplements may be added 64 to the selected food to facilitate increasing nutritional content of the selected food, to facilitate increasing therapeutic characteristics of the selected food, and/or to facilitate changing and/or increasing flavor of the selected food. Any suitable supplements may be added 64, such as, but not limited to, vitamins, herbs, and/or fatty acids. Moreover, one or more supplements may be added 64 to the selected food at any suitable time during method 50. In the exemplary embodiment, one or more supplements are added 64 to the selected food after pureeing 56 and before chilling 58.

The herein-described methods and trays facilitate providing nutritious and flavorful food that is convenient to store and consume. For example, the methods and trays described and/or illustrated herein may include freezing generally fresh organic food that is free of refined sugars and synthetic chemicals. By cooking the food prior to freezing at a temperature no greater than about 212° and/or for a duration of between about two minutes and about thirty minutes, the methods and trays described and illustrated herein may facilitate retaining more nutrients within the food and/or retaining more of the food's raw flavor. Because the food is frozen, it may be convenient to store, may be easily defrosted and/or heated for consumption, and/or may remain fresh longer. Moreover, because the tray described and illustrated herein includes a plurality of separate compartments of frozen food, the methods and trays described and illustrated herein may facilitate reducing an amount of food wasted. For example, many parents throw away unfinished jars of baby food because the jarred food may spoil before the jar can be finished. However, because the tray described and illustrated herein includes a plurality of separate compartments of frozen food, frozen food can be removed from only as many compartments as the baby's appetite demands, and the remaining compartments with frozen food can be stored until needed.

Exemplary embodiments of methods and trays are described and/or illustrated herein in detail. The methods and trays are not limited to the specific embodiments described herein, but rather, steps of each method and components of each tray may be utilized independently and separately from other steps and/or components described herein. Each method step and component can also be used in combination with other method steps and/or components.

When introducing elements/components/steps/etc. of the methods and trays described and/or illustrated herein, the articles “a”, “an”, “the”, “said”, and “at least one” are intended to mean that there are one or more of the element(s)/component(s)/step(s)/etc. The terms “comprising”, “including” and “having” are intended to be inclusive and mean that there may be additional element(s)/component(s)/step(s)/etc. other than the listed element(s)/component(s)/step(s)etc.

While the invention has been described in terms of various specific embodiments, those skilled in the art will recognize that the invention can be practiced with modification within the spirit and scope of the claims.

What is claimed is:

1. A method for processing food using a tray having a plurality of substantially similarly-sized compartments, said method comprising:
at least partially filling at least two of the plurality of substantially similarly-sized tray compartments with an organic food; and
flash-freezing the organic food within the plurality of substantially similarly-sized tray compartments.

2. A method in accordance with claim 1 further comprising cooking the organic food before at least partially filling the tray compartments with the organic food.

3. A method in accordance with claim 1 further comprising pureeing the organic food before at least partially filling the tray compartments with the organic food.

4. A method in accordance with claim 3 wherein pureeing the organic food further comprises pureeing the organic food to a consistency of one of a thin liquid, a medium liquid, a thick liquid, and a thick liquid having chunks.

5. A method in accordance with claim 1 further comprising adding a supplement to the organic food before at least partially filling the tray compartments with the organic food.

6. A method in accordance with claim 5 wherein adding a supplement to the organic food further comprises adding at least one of a vitamin, an herb, and a fatty acid to the organic food.

7. A method in accordance with claim 1 further comprising reducing the temperature of the organic food using a chilling process before at least partially filling at least two of the plurality of substantially similarly-sized tray compartments with the organic food.

8. A method in accordance with claim 7 wherein chilling the organic food further comprises chilling the organic food to a temperature of between about 35° F. and about 65° F.

9. A method in accordance with claim 1 further comprising sealing at least one of the plurality of substantially similarly-sized tray compartments before freezing the organic food and after at least partially filling the tray compartments with the organic food.

10. A method in accordance with claim 9 wherein sealing at least one of the plurality of substantially similarly-sized tray compartments further comprises sealing the at least one of the plurality of substantially similarly-sized tray compartments by applying a plastic film to the tray.

11. A method in accordance with claim 1 wherein at least partially filling the tray compartments with the organic food further comprises at least partially filling each of the at least two of the plurality of substantially similarly-sized tray compartments with about one ounce of the organic food.

12. A method in accordance with claim 1 wherein at least partially filling the tray compartments with the organic food further comprises at least partially filling the at least two of the plurality of substantially similarly-sized tray compartments with organic baby food.

13. A method in accordance with claim 1 wherein at least partially filling the tray compartments with the organic food further comprises at least partially filling the at least two of the plurality of substantially similarly-sized tray compartments with organic food that does not include at least one of refined sugar and a synthetic chemical.

14. A method in accordance with claim 1 wherein at least partially filling the tray compartments with the organic food further comprises at least partially filling the at least two of the plurality of substantially similarly-sized tray compartments with at least one of an organic vegetable, an organic meat, an organic fruit, an organic grain, an organic grain product, and an organic dairy product.

15. A method in accordance with claim 1 wherein at least partially filling the tray compartments with the organic food further comprises at least partially filling a first compartment of the plurality of substantially similarly-sized tray compartments with a first organic food and at least partially filling a second compartment of the plurality of substantially similarly-sized tray compartments with a second organic food different from the first organic food.

16. A method in accordance with claim 1 wherein at least partially filling the tray compartments with the organic food further comprises at least partially filling the at least two of the plurality of substantially similarly-sized tray compartments with a food that is certified organic by the United States Department of Agriculture.

17. A method in accordance with claim 1 wherein flash-freezing the organic food further comprises exposing the organic food to a temperature that causes a temperature of the organic food to drop below 32° F. within less than ten seconds.

18. A method for processing food using a tray having a plurality of compartments, said method comprising:
cooking food to a temperature no greater than about 212° F. for a duration of between about two minutes and about thirty minutes;
at least partially filling at least one of the plurality of tray compartments with the food; and
freezing the food within the plurality of tray compartments.

19. A method in accordance with claim 18 further comprising pureeing the food before at least partially filling the tray compartments with the food.

20. A method in accordance with claim 19 wherein pureeing the food further comprises pureeing the food to a consistency of one of a thin liquid, a medium liquid, a thick liquid, and a thick liquid having chunks.

21. A method in accordance with claim 18 further comprising adding a supplement to the food before at least partially filling the tray compartments with the food.

22. A method in accordance with claim 21 wherein adding a supplement to the food further comprises adding at least one of a vitamin, an herb, and a fatty acid to the food.

23. A method in accordance with claim 18 further comprising chilling the food before at least partially filling the tray compartments with the food.

24. A method in accordance with claim 23 wherein chilling the food further comprises chilling the food to a temperature of between about 35° F. and about 65° F.

25. A method in accordance with claim 18 further comprising sealing at least one of the plurality of tray compartments before freezing the food and after at least partially filling the tray compartments with the food.

26. A method in accordance with claim 25 wherein sealing at least one of the plurality of substantially similarly-sized tray compartments further comprises sealing the at least one of the plurality of substantially similarly-sized tray compartments by applying a plastic film to the tray.

27. A method in accordance with claim 18 wherein cooking food further comprises cooking the food in water.

28. A method in accordance with claim 18 wherein at least partially filling the tray compartments with the food further comprises at least partially filling each of the at least one of the plurality of tray compartments with about one ounce of the food.

29. A method in accordance with claim 18 wherein at least partially filling the compartments with the food further comprises at least partially filling the at least one of the plurality of substantially similarly-sized tray compartments with baby food.

30. A method in accordance with claim 18 wherein at least partially filling the tray compartments with the food further comprises at least partially filling the at least one of the plurality of tray compartments with food that does not include at least one of refined sugar and a synthetic chemical.

31. A method in accordance with claim 18 wherein at least partially filling the tray compartments with the food further comprises at least partially filling the at least one of the plurality of tray compartments with at least one of a vegetable, a meat, a fruit, a grain, a grain product, and a dairy product.

32. A method in accordance with claim 18 wherein at least partially filling the tray compartments with the food further comprises at least partially filling a first compartment of the plurality of tray compartments with a first food and at least partially filling a second compartment of the plurality of tray compartments with a second food different from the first food.

33. A method in accordance with claim 18 wherein freezing the food further comprises flash-freezing the food.

34. A method for processing baby food using a tray having a plurality of compartments, said method comprising:
cooking food;
pureeing the cooked food to a consistency suitable for consumption by a human baby between the ages of about six months and about eighteen months;
chilling the pureed food;
at least partially filling each of the plurality of tray compartments with the chilled food; and
freezing the chilled food within the plurality of tray compartments.
